(19) United States
(12) Patent Application Publication
(10) Pub. No.: US 2011/0279270 A1
(43) Pub. Date: Nov. 17, 2011

(54) INTRUDER DETERRENT

(75) Inventors: A. Hunt Marckwald, Quogue, NY (US); Bruce A. Moore, Flanders, NY (US); Patrick C. Harris, Medford, NY (US)

(73) Assignee: PYTHON INTRUDER DETERRENT SOLUTIONS, LLC, Quogue, NY (US)

(21) Appl. No.: 12/778,704

(22) Filed: May 12, 2010

(51) Int. Cl. G08B 13/00; G08B 13/08

(52) U.S. Cl. 340/545.1; 340/541

(57) ABSTRACT

The present invention relates to an alarm system that incorporates wireless technology along with cellular telephone service technology for example, to provide a unique and effective deterrent to illegal entry. The present invention further relates to an alarm system that first captures images of an intruder and then attacks the intruder with high intensity strobe lighting and audible signal broadcast in multiple pure square tones at high volume, creating an intolerable environment and triggering a “flight response” in the intruder.

### BACKGROUND OF THE INVENTION

1. Field of the Invention

The present invention relates to a method and an alarm system for driving an intruder from an area being secured. Specifically, the present invention relates to an alarm system for attacking an intruder with high intensity strobe lighting and sound broadcast in multiple pure square tones at a high volume from a plurality of deterrent devices to trigger a flight response in the intruder.

2. Description of the Related Art

Various types of alarm systems have been known in the art for many years. Alarm systems are now available for automobiles as well as for building structures, such as homes, businesses, warehouses and estate properties. Most current alarm systems in use today are hard wired throughout the building structure and the wiring usually terminates at a master unit or “brain” located somewhere within the building structure. However, the installation of large in-home alarm systems can be labor intensive and cost prohibitive. Additionally, current in-home alarms systems tend to be limited in the areas they cover making it easy for intruders to maneuver within a large home without being detected. Lastly, the failure of traditional alarm systems to trigger a flight response in an intruder and the slow response time of police responders enables intruder to remain in the home for a sufficient enough period of time for them to steal expensive items and absconding without being caught.

Thus, there exists a need in the art for an alarm system that can be easily installed inexpensively. There is also a need for the alarm system to cover an entire area to be secured. There is also a need for the alarm system to trigger a flight response in the intruder to prevent the intruder from stealing any items from the area to be secured. There is also a need for the alarm system to be wireless, and capable of placing a call without the need of the hard wired telephone system in place at the area to be secured.

### SUMMARY OF THE INVENTION

In view of the foregoing background, the present invention relates to a method and an alarm system that incorporates wireless technology along with cellular telephone service technology for example, to provide a unique and effective deterrent to illegal entry. The present invention further relates to a system that first captures images of an intruder and then attacks the intruder with high intensity strobe lighting and audible signal broadcast in multiple pure square tones at high volume, creating an intolerable environment and triggering a “flight response” in the intruder. In this way, the alarm system is configured to effectively identify an intruder for future apprehension, but then drive the intruder away from the area to be secured.

### BRIEF DESCRIPTION OF THE DRAWINGS

The details of the present invention, both as to its structure and operation, can best be understood by referring to the accompanying drawings, in which like reference numbers and designations refer to like elements.

FIG. 1 is an exemplary block diagram of an alarm system according to an embodiment of the present invention.

FIG. 2a is a front view of a deterrent device according to an embodiment of the present invention.

FIG. 2b is an uncovered front view of a deterrent device according to an embodiment of the present invention

FIG. 2c is a rear view of a deterrent device according to an embodiment of the present invention.

FIG. 3 is an exemplary flow-chart of a process for deterring an intruding using the alarm system of FIG. 1 according to an embodiment of the present invention.

### DETAILED DESCRIPTION OF THE INVENTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

The present invention relates to an alarm system that incorporates wireless technology along with cellular telephone service technology for example, to provide a unique and effective deterrent to illegal entry. The present invention further relates to an alarm system that first captures images of an intruder and then attacks the intruder with high intensity strobe lighting and audible signal broadcast in multiple pure square tones at high volume, creating an intolerable environment and triggering a “flight response” in the intruder.

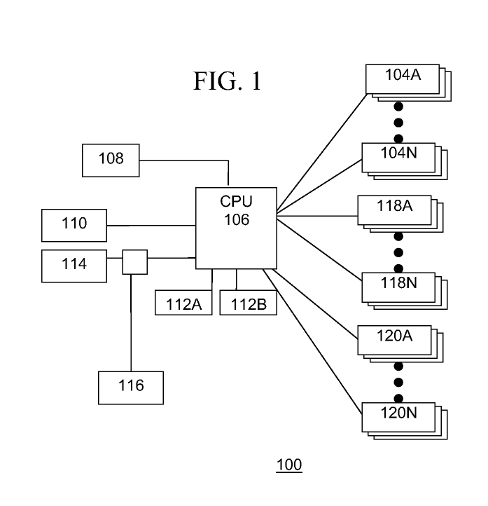

An alarm system according to an embodiment of the present invention is shown in FIG. 1. According to the embodiment of FIG. 1, the alarm system 100 of the present invention includes a master unit 102, at least four deterrent devices 104A-104D in wired or wireless communication with master unit 102, a power supply 114, a battery 116, a plurality of security contact switches 118A-118N, and a plurality of sensors 120A-120N. In the FIG. 1 embodiment of the present invention, the master unit 102 contains a motherboard 106 (CPU), a receiver 108, a keypad 110, and two cellular transceivers 112A-112B. In an embodiment of the present invention, the master unit may also include a router or modem capable of connecting to the internet (not shown). In an embodiment of the present invention, a ceiling unit 122 is included in system 100.

In the FIG. 1 embodiment of the present invention, the CPU 106 processes signals that it receives from the various components in the alarm system 100 and receives power from power supply 114, which is connected to a conventional AC power source (not shown), or alternatively from battery 116. In an embodiment of the present invention, CPU 106 is notified when there is a power failure or a lack of current from power supply 114 and activates battery 116 to provide power to CPU 106. The battery for use with the present invention is capable of maintaining the alarm system in a stand-by mode for about 24 hours, and then actively run the entire system for about 1 hour. In an embodiment of the present invention, the power supply 114 is a transformer that receives power from an AC power source, transforms AC current to DC current, and provides the DC current to CPU 106. Battery 116 is operable to be charged by power supply 114 as directed by CPU 106. Receiver 108 receives wireless signals transmitted from each of the plurality of security contacts switches 118A-118N, each of the plurality of sensors 120A-120N, and each of the plurality of deterrent devices 104A-104D for processing by CPU 106.

In an embodiment of the present invention, the plurality of security contacts switches 118A-118N are provided on doors and windows of an area to be secured, such as a building structure, being secured by the alarm system 100. Areas to be secured include, but are not limited to, outdoor areas, structures, areas within a structure, buildings, vehicles, yachts and ships of all varieties. The contact switches 118A-118N can be hard-wired to CPU 106, in wireless communication with CPU 106 via receiver 108, or a combination thereof. Each of the plurality of contact switches 118A-118N will activate and notify the CPU 106 when the connection of a respective contact switch is broken by the opening of the door or window to which the respective contact switch is provided. When the CPU receives the notification it will trigger a response including, but not limited to, initiating an high intensity strobe lighting, an audible signal broadcast in multiple pure square wave tones at high volume, and one or more telephone calls to pre-determined telephone number(s) as described in detail herein below.

In an embodiment of the present invention, the plurality of sensors 120A-120N include, but are not limited to, a hard-line sensor 120A, a power supply sensor 120B, a cold temperature sensor 120C, a smoke detector 120D, and a carbon monoxide detector 120E. The plurality of sensors can be hard-wire to CPU, in wireless communication with CPU 106 via receiver 108, or a combination thereof. The hard-line sensor 120A detects when the traditional telephone line is incapable of performing a telephone call and notifies the CPU 106 to initiate one or more telephone calls to pre-determined telephone number(s) using cellular transceivers discussed herein below.

The power supply sensor 120B detects when the CPU is not receiving power from power supply 114 and notifies the CPU 106 to initiate one or more telephone calls to pre-determined telephone number(s) and use battery 116 as a power source. Likewise, the power supply sensor 120 detects when power from power supply 114 has been restored and notifies the CPU 106 to discontinue the use of battery 116 as a power source. The cold temperature sensor 120C detects when the temperature within the area to be secured is below a specified temperature and notifies the CPU 106 to initiate one or more telephone calls to pre-determined telephone number(s), such as the owner of the area to be secured, heating unit repair shop, and central station. The smoke detector 120D detects when there is smoke within the area to be secured and notifies the CPU 106 to initiate an audible alarm and one or more telephone calls to pre-determined telephone number(s), such as the owner of the area to be secured, fire department and central station. The carbon monoxide detector 120E detects the presences of carbon monoxide within the area to be secured and notifies the CPU 106 to initiate an audible alarm and one or more telephone calls to pre-determined telephone number(s), such as the owner of the building structure, fire department and central station. The motion detector 120F detects the presence of motion in an area to be secured and notifies the CPU 106 to trigger a response including, but not limited to, initiating a high intensity strobe lighting, an audible signal broadcast in multiple pure square wave tones at high volume, and one or more telephone calls to pre-determined telephone number(s), such as the owner of the area to be secured, police station, and central station.

In an embodiment of the present invention, the CPU 106 is wired to a traditional telephone line and operable to initiate telephone calls to a plurality of destinations including, but not limited to, the owner of the area to be secured being monitored by alarm system 100, a central station, a fire station, police station, plumber, heating unit repair shop, and any other destination having a telephone. In an embodiment of the present invention, CPU 106 is operable to communicate with cellular transceivers 112A-112B and initiate wireless telephone calls to the plurality of the destinations specified herein above using one or more of cellular transceivers 112A-112B. In an embodiment of the present invention, a telephone call is provided with a pre-recorded message for the respective destination.

In an embodiment of the present invention, each of the plurality of deterrent devices 104A-104D is provided in an area to be secured. In an embodiment of the present invention, one or more rooms of a building structure can have a deterrent device secured to the floor of each corner of the one or more rooms of the building structure. Multiple deterrent devices may be linked in series to cover an area of any size. The deterrent devices 104A-104D can be hard-wired to CPU 106, in wireless communication with CPU 106 via receiver 108, or a combination thereof.

In the FIG. 1 embodiment of the present invention, a keypad 110 is coupled electrically to CPU 106 to enable the programming of the alarm system 100 according the specific needs of the user. The keypad is operable to allow a user to manually program the alarm system 100 to perform various functions including, but not limited to, activating the system, deactivating the system, programming pre-recorded messages, programming telephone numbers for various destination to be called by the alarm system as instructed by CPU 106 when the CPU is notified of a detection by a sensor or contact switch, changing the codes for activating and deactivating the alarm system, and changing the alarm settings. In an embodiment of the present invention, the alarm system can be activated and deactivated using a key fob. The alarm settings include the features on each deterrent device (i.e. strobe lights, camera, motion detector, audible signal) and the alarm system as a whole. At least one deterrent device of the present invention may also include and IP or network camera. Those skilled in the art will understand that any IP or network camera may be appropriate for use with the present invention. In an embodiment, the IP or network camera for use with the present invention is capable of recording between 20 and 30 still shots per second. Additionally the alarm system of the present invention may include a fog or smoke machine. In an embodiment of the present invention, status indicators are provided on the keypad 110 indicating the status of the alarm system with respect to one or more of the programmable features of the alarm system and deterrent devices.

For example, a user can use the keypad 110 to activate particular deterrent devices without activating other deterrent devices. For example, the alarm system 100 of the present invention can be programmed with a panic mode whereby the entry of a specific code using keypad 110 will initiate high intensity strobe lighting, an audible signal broadcast in multiple pure square tones at high volume, and one or more telephone calls to pre-determined telephone number(s). Additionally, the alarm system of the present invention can be programmed with multiple user access codes to allow multiple users to engage and disengage alarm system 100 through the entry or the respective access codes using the keypad 110. In a preferred embodiment of the present invention, the keypad 100 interface of the present invention can be programmed so that the alarm system 100 monitors specific zones or rooms in a building structure using the plurality of contact switches 118A-118N, and motion sensors, where each contact switch and motion sensor is assigned to specific zones.

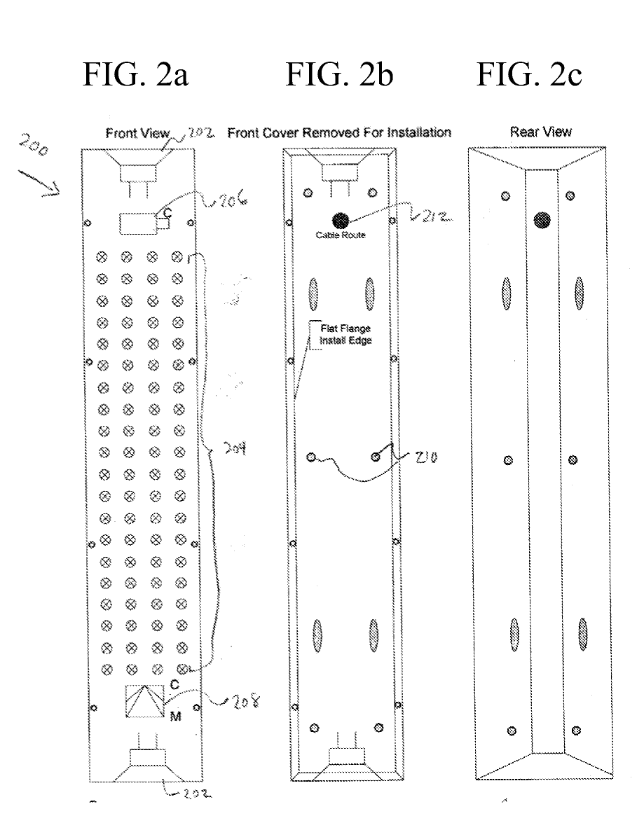

The monitoring and deterrent aspects of the present invention may be accomplished by the plurality of deterrent devices. FIGS. 2a-2c show different views of a representative deterrent device 104 according to an embodiment of the present invention. A front view of a deterrent device 104 according to an embodiment of the present invention is shown in FIG. 2a. In the FIG. 2a embodiment of the present invention, the deterrent device 200 includes a speaker 202, a plurality of strobe lights 204, a camera 206, a motion detector 208, a plurality of cellular transceivers (not shown), and a cooling fan (not shown).

As shown in the FIG. 2a embodiment, the design and shape of the deterrent device 104 is configured to be mounted in a corner. However, one having ordinary skill in the art would recognize that the deterrent device 200 can be designed and shaped according to a specific desired use or room configuration. For example, in a square shaped room, it may be preferable to have at least one mounted deterrent device shaped and designed to fit in the center of a wall. In other embodiments, the mounted deterrent devices may be shaped or designed to mount to a ceiling, ceiling corners or along the floor of a room. It is also possible that the mounted deterrent devices are not mounted. Rather, a deterrent device may be shaped or designed to stand freely or rest on a table, shelf or other surface. In an embodiment of the present invention, a deterrent device can be made of materials including, but not limited to, aluminum, steel, copper, and polyurethane. In an embodiment of the invention, the height and the width of the deterrent devices are selected based on the size of the area to be secured. For example, the size of the deterrent devices for use in a warehouse would be larger that the size of deterrent devices for use in yachts. In an embodiment of the present invention, the deterrent devices are portable, where they can be easily carried from on area to another.

In the FIG. 2a embodiment of the present invention, a plurality of speakers 202 is provided on the deterrent device 200. The plurality of speakers 202 broadcast an audible signal in multiple pure square wave tones, which is triggered by the CPU 106 in response to a notification that the connection of a contact switch has been broken, and/or a motion sensor has detected motion in an area of the building structure. The speakers 202 may be of any brand or type known to those of skill in the art. In a preferred embodiment, the speakers are piezoelectric speakers. In a more preferred embodiment, the speakers are piezoelectric speakers with a thickness of about 0.7 mm.

In an embodiment of the invention, the frequency of the audible signal broadcast by each speaker varies between each speaker at specified intervals. In an embodiment of the present invention, the frequencies between the speakers changes so that they are out of phase with one another. For example, the frequencies of the speakers may change multiple times per second within the range of 60 Hz to 5 kHz. In an embodiment of the present invention, the frequency range of the audible signal is between 60 Hz to 200 Hz, 200 Hz to 0.5 Hz, 1 kHz to 5 kHz, 0.5 kHz to 2.5 kHz, and 5 kHz to 10 kHz. In an embodiment of the present invention, the audible signal can be broadcast at a wide range of decibels. For example, the audible signal may be broadcast between 60-194 dB. In an embodiment of the invention, the audible signal is broadcast between about 90 dB and 120 dB.

In the FIG. 2a embodiment of the present invention, a plurality of high intensity strobe lights 204 is provided on deterrent device 200. Each of the plurality of strobe lights can be a cool white LED strobe light. Strobe lights emitting all ranges of lumens are appropriate for use with the present invention. For instance, the strobe lights may emit from about 3 lumens to about 200 lumens. In an embodiment, the strobe lights 204 can be 80 to 90 lumens, 120-150 lumens, and/or 180 to 200 lumens. In an embodiment of the present invention, the strobe lights 204 of each deterrent device 200 can be programmed to illuminate at intermittent intervals to allow the cameras of other deterrent devices 200 to take pictures of the intruder. A smoke or fog machine may also be provided with the present invention as a further deterrent.

In the FIG. 2a embodiment of the present invention, a motion detector is provided on deterrent device 200. Each motion sensor on a respective deterrent device can activate and notify the CPU 106 of motion detected by the motion sensor using receiver 108. When the CPU receives the notification it will trigger a response including, but not limited to, initiating a high intensity strobe lighting 204, an audible signal broadcast in multiple pure square tones at high volume, and one or more telephone calls to pre-determined telephone number(s). The strobe lights and audible signal, when activated, immobilize intruders by attacking both the sense of sight and sense of hearing. In this way, the alarm system of the present invention, upon activation, creates a chamber of unpleasant surroundings.

An uncovered front view of a deterrent device 200 according to an embodiment of the present invention is shown in FIG. 2b. As shown, the deterrent device is provided with mounting holes 210 for securing deterrent device 200 to a surface of a building structure. The deterrent device 200 is also provided with a hole 212 for routing any wiring to and from the deterrent device 200.

FIG. 2c is a rear view of a deterrent device according to an embodiment of the present invention. As shown, the deterrent device is shaped for positioning in a corner of a room.

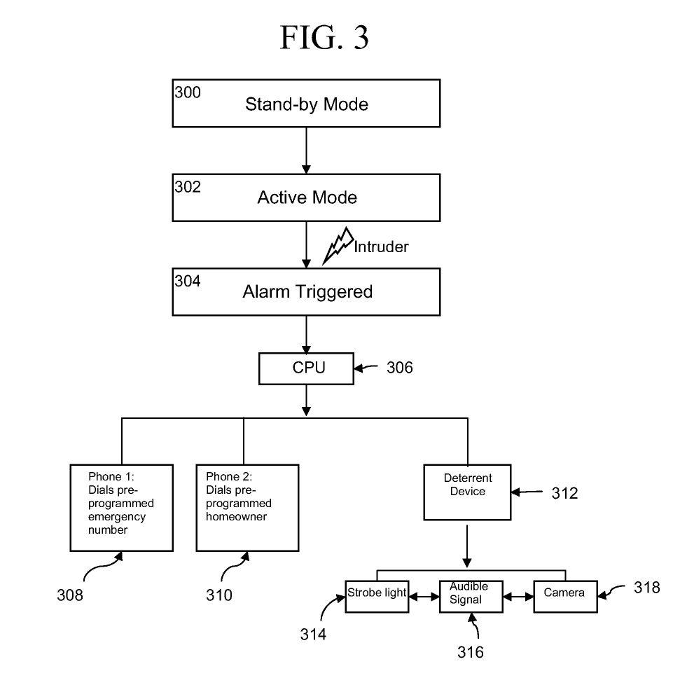

In the FIG. 3 embodiment of the present invention, the alarm system of FIG. 1 is maintained in a “stand-by” mode 300 until it is programmed into an “active” mode 302, either through the control panel, key fob, or remotely through a cellular or wireless device. Once placed in the active mode 302, the alarm is operable to be triggered by an intruder by any of the several means mentioned herein above. For example, an intruder can trigger the alarm by opening a door or window. An intruder can also trigger the alarm system by crossing a motion detector connected to the alarm system. Upon triggering the alarm system 304, the CPU then signals the entire alarm cascade. For example, the CPU can send a pre-recorded message to a pre-programmed emergency response number including, but not limited to, the police, security service and central station through a first phone 308, and the CPU can send a pre-recorded message to additional pre-programmed phone numbers, including the property owner's phone number, through a second phone 310. Additionally, the CPU sends a signal to each of the deterrent devices 312 to activate the various alarm features including, but not limited to, strobe lights 314, audible signals 316, and cameras 318, each of which can operate in concert with the other. In an embodiment of the present invention, the audible signal of each deterrent is activated and the frequencies between the speakers are changed so that they are out of phase with one another during the activation period. For example, the frequencies of each of the speakers may change multiple times per second during the activation. In an embodiment of the present invention, the strobe lighting of each deterrent device is activated and illuminated at intermittent intervals during the activation period. In an embodiment of the present invention, a camera of a deterrent device takes a picture of the environment to capture an image or facial picture of the intruder. The camera of a deterrent device is programmed to take a picture when the strobe lighting of a deterrent device that is facing opposite of it is not illuminating. This rhythmic process between the strobe lighting and cameras can be cyclically performed between each camera on each deterrent the strobe light. The process should be timed so that when a picture is being taken by a deterrent device the strobe lighting does not make the image unrecognizable.

What is claimed is:

1. An alarm system comprising:
a master unit; and
at least four deterrent devices operable to communicate with the master unit;
wherein, the at least four deterrent devices comprise a plurality of strobe lights, a camera, at least a first speaker, and a motion detector;
wherein the master unit is operable to receive communications from the at least four deterrent devices and operable to trigger a cascade of security features in response to the communications from the at least four deterrent devices; and
wherein the cascade of security features comprises activating a first telephone connection, activating a second telephone connection, activating the plurality of strobe lights on the at least four deterrent devices, activating the at least first speaker on each of the at least four deterrent devices to broadcast in multiple pure square tones of changing frequency, and activating the camera on each of the at least four deterrent devices to capture an image of an intruder in between strobe light flashes.

2. The alarm system of claim 1, further comprising a power supply.

3. The alarm system of claim 1, wherein the master unit comprises a CPU, a receiver, a keypad, a first telephone connection, and a second telephone connection.

4. The alarm system of claim 1 further comprising a batter.

5. The alarm system of claim 1 further comprising a remote activation device.

6. The alarm system of claim 1, wherein the speaker of the at least four deterrent devices is operable to change frequencies multiple times per second within a range of 60 Hz and 5 kHz.

7. The alarm system of claim 1, wherein the master unit further comprises a router operable to provide connectivity to the internet.

8. The alarm system of claim 1, wherein at least one of the first telephone connection and the second telephone connection comprises a cellular transceiver.

9. The alarm system of claim 1, further comprising wireless sensors operable to trigger the alarm when a door or window is opened.

10. A deterrent device comprising:
a motion detector and a series of security features comprising
a plurality of strobe lights;
a camera;
a speaker operable to broadcast in multiple pure square tones of changing frequency;
wherein, each of the security features is connected to operate in series following detection by the motion detector; and
wherein the security features operate by activating the plurality of strobe lights and the speaker, and then activating the camera to capture an image of an area in between flashes of a plurality of strobe lights of a second deterrent device.

11. The deterrent device of claim 10, wherein the speaker is operable to broadcast between a range of about 60 dB and about 194 dB.

12. The deterrent device of claim 10, further comprising at least one additional security feature selected from the list comprising an IP camera, a network camera, a fog machine, a smoke detector, a cold detector, a cooling fan, and a plurality of cellular transceivers.

13. The deterrent device of claim 10, wherein the deterrent device is shaped to be mounted to a ceiling or floor.

14. The deterrent device of claim 10, wherein the deterrent device is shaped to rest on a flat surface.

15. The deterrent device of claim 10, wherein the speakers are piezoelectric speakers.

16. A method for securing an area comprising:
maintaining a security device in a stand-by mode
programming the security device into an active mode
detecting an intruder at a remote point and triggering the alarm system by notifying the CPU of the intruder detected
activating an alarm response cascade comprising initiating high intensity strobe lighting, initiating an audible signal broadcast in multiple pure square tones, initiating a camera to capture the image of the intruder, initiating a first telephone connection to dial a pre-preprogrammed number, and initiating a second telephone connection to dial a pre-programmed number.

17. The method of claim 16, wherein the alarm cascade further comprises initiating a fog machine.

18. The method of claim 16, wherein the initiating a first telephone connection to dial pre-programmed numbers further comprises delivering a pre-recorded message to the pre-programmed numbers.
